(19) United States
(12) Patent Application Publication
(10) Pub. No.: US 2023/0216328 A1
(43) Pub. Date: Jul. 6, 2023

(54) CHARGING DEVICE FOR CHARGING ELECTRICAL ENERGY STORAGE DEVICES

(71) Applicant: VOITAS Innovations GmbH, Reichertshofen (DE)

(72) Inventor: Armin HAGER, Geisenfeld (DE)

(73) Assignee: VOITAS Innovations GmbH, Reichertshofen (DE)

(21) Appl. No.: 18/145,997

(22) Filed: Dec. 23, 2022

(30) Foreign Application Priority Data
Dec. 31, 2021 (DE) 102021006497.6

(51) Int. Cl. H02J 7/00; H02G 11/02

(52) U.S. Cl. CPC H02J 7/007192; H02G 11/02; H02J 7/0042; H02J 7/00309

(57) ABSTRACT

The invention includes a charging device for charging electrical energy storage devices, which has a cable reel, a charging cable, a measuring unit and a charging control unit. The measuring unit forwards a measured value of a temperature to the charging control unit, which controls a charging process of the electrical energy storage device based on the measured value of the temperature. If the temperature measured value, which is measured by the measuring unit, exceeds a predetermined threshold value, the charging control unit controls the charging current in such a way that it is reduced so that the temperature is decreased.

### CROSS-REFERENCE TO RELATED APPLICATIONS

This application claims priority from German Patent Application No. 102021006497.6, filed Dec. 31, 2021; the disclosure of which is incorporated herein by reference in its entirety.

### FIELD

The following disclosure refers to a charging device for charging an electrical energy storage device.

### BACKGROUND

Devices for charging electrical energy storage devices, such as for example battery systems of electric vehicles, have gained enormously in importance in recent years, since particularly the use of electric cars has been strongly promoted. For electric cars to be charged, they are connected to a public or private charging station via a charging cable. There is usually no charging cable at public charging stations and the operator of the electric car must carry it with themselves and plug it in if necessary.

The operator of the electric car is therefore usually forced to carry a charging cable with themselves and to store it appropriately. This problem can be avoided in private charging stations, as they can be provided with a permanently installed charging cable, which is stored at the private charging station. There are already numerous solutions for this in the state of the art. The charging cable is here usually wound by hand on a fixed holding device for the charging cable.

However, manual winding of charging cables has several disadvantages. For one thing, manual winding increases the time required and, for another thing, incorrect winding can cause damage to the charging cable. In addition, for safety reasons, the operator must completely unwind the charging cable, as a result of which the aforementioned disadvantages occur regularly.

### SUMMARY

The object of this disclosure is to provide an alternative charging device for charging electrical energy storage devices, which does not have the above disadvantages and ensures simple, reliable and damage-free handling.

The object is achieved with the features of the independent claims. Further advantageous embodiments and refinements are the subject matter of the subsequent claims.

The invention includes a charging device for charging electrical energy storage devices, which has a cable reel, a charging cable, a measuring unit and a charging control unit.

The charging cable, which is configured to supply the electrical energy storage devices with power, is accommodated in the cable reel, wherein the cable reel is equipped with a winding mechanism via which the charging cable can be manually wound or unwound or automatically wound or unwound, wherein, however, manual winding of the charging cable is not required.

The winding mechanism comprises an integrated spring, with the spring pretensioning with a force against unrolling of the charging cable. Thus, the winding mechanism is configured in such a way that the charging cable is permanently subjected to a counterforce, as a result of which tension on the charging cable is kept at all times.

In addition, the cable reel, having the winding mechanism, includes a charging cable guide that guides the charging cable during automatic winding, so that the charging cable is wound in a predetermined manner.

Unwinding the charging cable provides a required length of the charging cable for the charging of the electrical energy storage device, while at the same time preventing the charging cable from becoming dirty or damaged. After the charging, the charging cable is automatically wound, which also prevents damage to the charging cable due to incorrect winding.

If the charging process of the electrical energy storage device takes longer and if the charging cable is not completely unwound, as the entire length of the charging cable was not required, it is possible that strong heat will develop. In a case where the temperature becomes too high, damage to the cable and/or the electric energy storage device can occur. Therefore, a measuring unit is provided, which has at least one temperature sensor which is configured to measure the temperature in the charging device.

The measuring unit forwards a measured temperature value to the charging control unit, which controls the charging process of the electrical energy storage device based on the measured temperature value. If the measured temperature value, which is measured by the measuring unit, exceeds a predetermined threshold value, the charging control unit controls the charging current in such a way that it is reduced, until the temperature decreases by a predetermined value. The charging current is then increased again.

In particular, the charging device for charging electrical energy storage devices has two relay units, the first relay unit enabling a three-phase charging and the second relay unit enabling a single-phase charging. A single-phase charging makes it possible to charge the electrical energy storage device with a low power. As a result, the charging current can be further reduced using this relay configuration if the temperature in the charging device falls too slowly. This enables rapid temperature control.

The configuration of the charging device for charging electrical power storage devices according to this disclosure makes it possible to reliably prevent damage to the charging cable for charging electrical power storage devices.

### BRIEF DESCRIPTION OF THE DRAWINGS

FIG. 1 is a three-dimensional overall view of a charging device for charging electrical energy storage devices according to the first embodiment.

FIG. 2 is a three-dimensional sectional view of the charging device for charging electrical energy storage devices according to the first embodiment.

FIG. 3 is a three-dimensional view of a cable reel according to the first embodiment, illustrating an internal wiring of the cable reel.

FIG. 4 is a schematic sectional view of the charging device according to the first embodiment, illustrating an internal installation space division and arrangement of a measuring unit.

FIG. 5 is a flowchart illustrating a control sequence of a control process performed by the charging control unit.

### DETAILED DESCRIPTION

Various embodiments of the invention are described below. Components which are identical across individual embodiments are given the same reference symbols. In addition, redundant descriptions of these components are omitted.

### First Embodiment

A charging device 1 for charging electrical energy storage devices according to a first embodiment comprises a housing 2, a charging cable 3 with a charging plug 4, a holding device 6, a power supply connection 7, a cable reel 8, a charging control unit 9, a relay pair 10, a power supply unit 11, a current sensor 12 and a measuring unit 13.

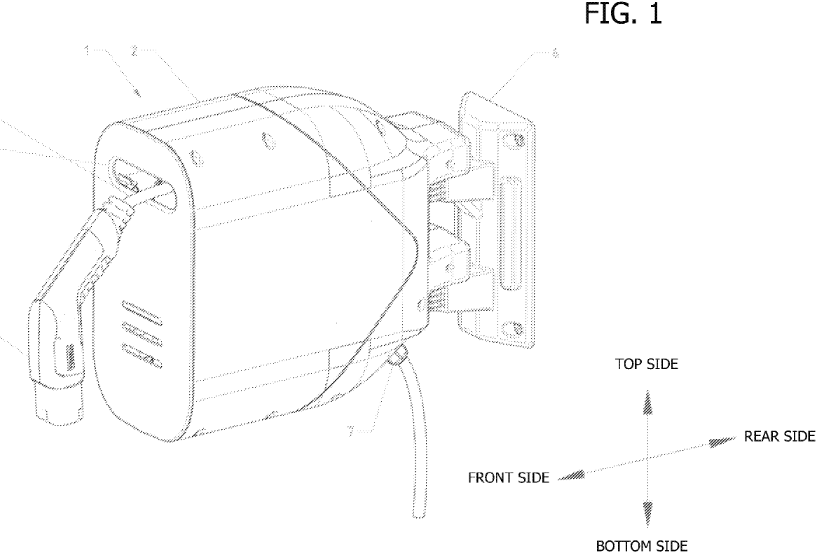

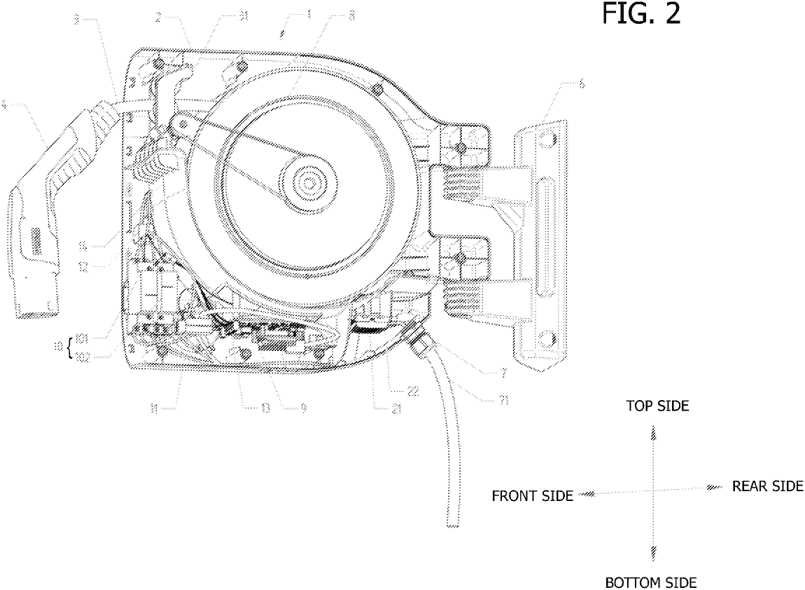

FIGS. 1 and 2 show a three-dimensional general view of the charging device for charging electrical energy storage devices according to the first embodiment. The charging device 1 comprises a housing which accommodates the charging cable 3, cable reel 8, charging control unit 9, relay pair 10, power supply unit 11, current sensor and measuring unit 13. In addition, a power supply connection 7, via which an external power supply line is connected, and a holding device 6, by means of which the charging device 1 can be fixed in a suitable place, are attached on the housing. A housing opening 5 is also formed in the housing 2. The charging cable 3 can be led out of the housing 2 via the housing opening 5.

The front side of the charging device 1 is defined as the side where the housing opening 5 is formed and which is located opposite the rear side of the charging device 1 where the holding device 6 is formed.

The top side of the charging device 1 is defined as the side located at the upper end of the housing 2 along the direction of the force of gravity. The bottom side of the charging device 1 is defined as the side located at the lower end of the housing 2 along the direction of the force of gravity.

As shown in FIG. 2, a large part of the interior space of the housing 2 is occupied by the cable reel 8. The cable reel 8 is configured in such a way that the charging cable 3 can be wound on the cable reel 8. In particular, the cable reel 8 has a winding mechanism that allows the charging cable 3 to be automatically wound on the cable reel 8. For this purpose, for example, a leaf spring (not shown) is provided inside the cable reel 8. This generates a counterforce (pretension force) as soon as the charging cable 3 is led out of the housing 2. It should be mentioned here that the charging cable 3 can already be at least partially led out of the housing opening 5 in an unloaded state in which the leaf spring does not exert any counterforce.

With the counterforce generated by the leaf spring, as soon as the charging cable 3 is pulled out of the housing opening 5 by a pulling force, the charging cable 3 is always kept under tension. The charging cable 3 can by any length, such as two to twelve meters, as long as a sufficient length of the charging cable 3 can be wound on the cable reel 8. The cable reel 8 thus enables the operator to unwind a required length of the charging cable 3, with the cable reel 8 preventing the charging cable 3 from coming into contact with the ground since it is kept under tension.

In addition, FIG. 2 shows the charging cable 3 which comprises a charging plug 4 and is led through a cable guide 31. The cable guide 31 is an element which is configured so that the charging cable 3 is wound onto the cable reel 8 in a predetermined manner when the pulling force is lower than the counterforce of the leaf spring. As a result, the charging cable 3 is always wound in the same way and kinking, bending or unintentional overlapping of the charging cable is prevented. The charging plug 4 is an element configured to connect the charging cable 3 to an electrical power storage device. The charging plug 4 can be a type 2 plug, for example, which is used to charge batteries or accumulators in electric vehicles. Of course, in principle, other plug types can also be used with the charging device according to the invention.

The holding device 6 shown in FIG. 2 is used to fix the charging device 1 in a suitable place. For example, the holding device 6 can be fixed, via a screw connection, to a wall or a kind of a column. Furthermore, the holding device 6 has rotating elements 61 which make it possible for the charging device 1 to be pivoted around an axis of rotation.

The power supply connection 7, which is attached to the housing 2, enables an external power supply line 71 to be connected to the charging device 1. The power supply connection 7 can be formed, for example, as a watertight cable bushing. The power supply line 71 is led inside the charging device 1 through the power supply connection 7 and securely held in place by the power supply connection 7.

The charging device 1 is used for charging electrical energy storage devices, wherein the charging process is controlled by the charging control unit 9. The charging control unit controls the charging process based on parameters such as temperature, power generation of a photovoltaic system, power demand in the electrical energy storage device, power consumption of a predetermined consumer, program settings and the like, and in particular, it adjusts a charging current based on these parameters. The parameters can be obtained from the charging control unit 9 e.g., via a wireless or wired communication interface, where the parameters are forwarded wirelessly or by wire from at least one external device.

In addition, a relay pair 10 is provided in the housing 2. The relay pair 10 is integrated into an internal wiring in the housing 2 and comprises in particular a first relay unit 101 and a second relay unit 102. The relay pair 10 is configured so that the charging device 1 can switch between a single-phase and three-phase charging, wherein the first relay unit enables a single-phase charging and the second relay unit enables a three-phase charging. As a result, the charging control unit 9 can provide a larger power range during the charging process. A charging process of common electrical energy storage devices, such as batteries of an electric vehicle, starts as soon as a sufficiently high charging current is available. With a single-phase charging, this sufficiently high charging current has to be provided for a single phase only, which is why the charging can be carried out even with a low power supply.

In addition, a power supply unit 11 and a current sensor 12 are arranged in the housing 2. The power supply unit 11 is provided to supply power to the charging control unit 9 and the charging cable 3 by being electrically connected to the external power supply line 71. The current sensor 12 is provided to measure a charging current controlled by the charging control unit 9.

As already mentioned, it can happen that the charging cable 3 is not completely unwound from the cable reel 8 as the entire length of the charging cable 3 is not required. In such a case, however, it is possible that due to the high power transmission in the case of a longer charging process there will be a strong heat generation inside the housing 2 and in particular in the cable reel 8 as a result of electromagnetic interference. A measuring unit 13 is provided in the housing 2 in order to prevent damage to the charging cable 3, charging control unit 9 and/or electrical energy storage device. In particular, the measuring unit comprises a temperature sensor that measures temperature inside the housing 2. The measuring unit 13 communicates with the charging control unit, with the measured temperature value of the measuring unit 13 serving as a parameter for controlling the charging current. A sequence of the control process for protecting the charging device 1 executed by the charging control unit 3 will be described later.

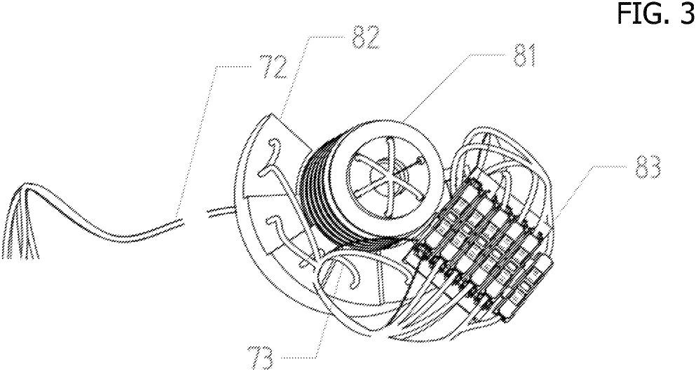

The connection between the charging cable 3, cable reel 8 and power supply line 71 is described below with reference to FIG. 3. The cable reel 8 has a cylindrical tube unit 81 located at a centre of rotation of the cable reel. The tube unit 81 extends along the axis of rotation and is open on both sides, with contact terminals, to which a wire can be connected, provided on one of the side surfaces of the tube unit 81. An internal wire connection line 72 forms an electrical connection between the power supply unit 11 and the contact terminals on the tube unit 81. The tube unit 81 is in turn in contact with a sliding contact element 82. The sliding contact element 82 is formed as an arch around the tube unit 81, it has transition wires 73 which are connected to the charging cable 3 via transition contact elements 83. The sliding contact element 82 is configured in such a way that corresponding paths of electrical lines are extended accordingly. This enables an electrical connection from the power supply unit 11 to the charging cable 3 and ensures that the cable reel 8 can rotate without any problems when the charging cable 3 is being unwound.

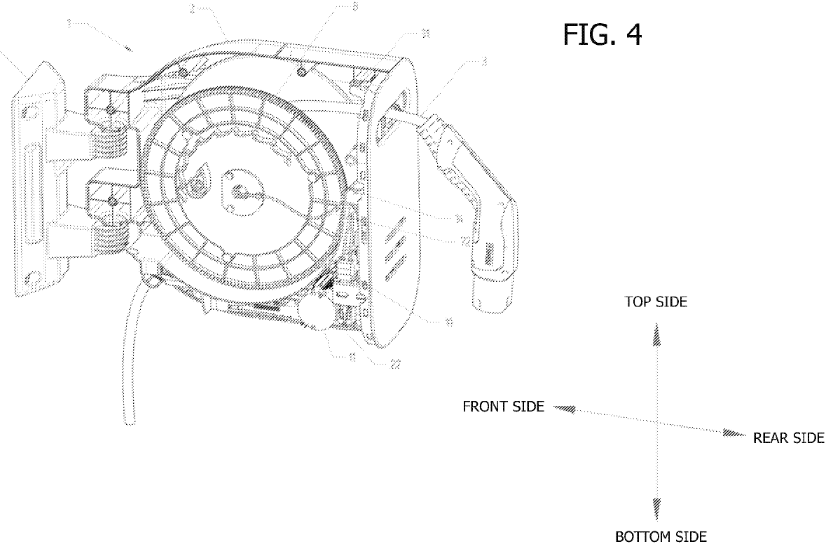

FIG. 4 is a schematic sectional view of the charging device 1 according to the first embodiment, which illustrates an internal installation space division and an arrangement of a measuring unit 13.

The interior of the housing 2 can be divided into three structural installation spaces. As already mentioned, the cable reel 8 occupies the largest installation space inside the housing 2. The size of the installation space is determined here by the cable reel 8, charging cable 3 and cable guide 31. The installation space in which the cable reel 8 is accommodated is referred to as the cable reel installation space 23. Furthermore, the measuring unit 13 is arranged in the cable reel installation space 23.

At the lower side of the cable reel 8, which is the side of the cable reel 8 in the direction of the lower side, the installation space inside the housing 2 is divided by a water drainage element 14, creating an installation space for electronic components below the cable reel installation space 23. The water drainage element 14 serves to drain away water which gets inside the cable reel installation space 23 e.g., when the charging cable 3 is being wound. Accordingly, the water drainage element 14 seals the installation space for electronic components against the cable reel installation space 23. At a point which is located furthest on the lower side, there is also a water drainage opening in the water drainage element 14, the opening opens the housing on the underside of the housing to the outside causing the water inside the housing 2 to drain away.

The installation space for electronic components is divided into a first electronics installation space 21 and a second electronics installation space 22 by a separating element. The first electronics installation space 21 accommodates the external line supply line 71. Inside the first electronics installation space 21 there is a connection element to which the external power supply line 71 is connected. The connection element in the first electronics installation space has a fixed cable duct to the second electronics installation space, which ensures a power supply, but the installation spaces are separated from one another.

The charging control unit 9, the relay pair 10, the power supply unit 11 and the current sensor 12 are thus accommodated in the second electronics installation space. The measuring unit 13 is electrically connected to the charging control unit 9, with the electrical connection between the measuring unit 13 and the charging control unit 9 being sealed so that it is waterproof. The division of the installation spaces ensures that the electronic components are protected from dirt and water. Furthermore, internal electronic components are supplied with power via a connection element in the first electronics installation space 21. The external power supply line 71 can thus be replaced without there being any risk of dirt or water getting inside the second electronics installation space 22. Thus, in turn, defects of electronic components can be prevented.

As already mentioned, the measuring unit 13 is provided inside the cable reel installation space 23. In the first embodiment, the measuring unit 13 comprises a temperature sensor which is arranged at a position which is, on the one hand, as close as possible to a periphery of the cable reel 8 and which is, on the other hand, furthest away from the housing opening 5. This can ensure that the temperature sensor of the measuring unit 5 measures temperature at a position where the temperature inside the housing 2 is closest to a maximum temperature. As a result, the charging control unit 9 works reliably and excessive temperatures do not occur inside the cable reel 8 and the charging device 1 can be operated safely.

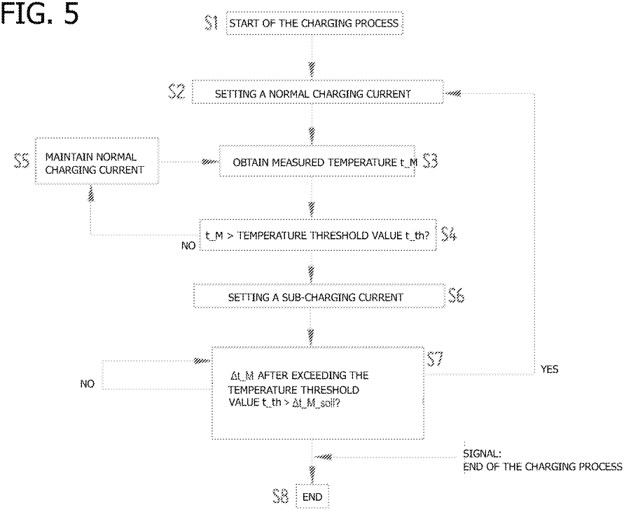

A control sequence of the control process, which is executed by the charging control unit 9 according to the first embodiment, will be described below with reference to FIG. 5.

In step S1 in FIG. 5, the charging process of an electrical energy storage device is started by the charging device 1. The charging process can be started manually by an operator or automatically by the charging device 1 based on an operating condition. The control process then proceeds to step S2.

In step S2, the charging control unit 9 sets a normal charging current. The normal charging current is a charging current that is set under normal operating conditions based on available power, manufacturer specifications for the electrical energy storage device, manual charging settings by the operator and/or the like. The control process then proceeds to step S3.

In step S3, the charging control unit 9 acquires the measured value of the temperature, which is detected by the measuring unit 3, as a measured temperature t_M. The control process then proceeds to step S4.

In step S4, the charging control unit compares the measured temperature t_M with a temperature threshold value t_th. The temperature threshold value t_th is a predetermined threshold value which is representative of the fact that a critical temperature has nearly been reached at the position of the temperature sensor. A critical temperature occurs when the temperature is so high that it can lead to damage to the charging cable 3 or in the electronic components. If it is determined in step S4 that the measured temperature t_M has not exceeded the temperature threshold value t_th (S4: NO), the control process moves to step S5. If it is determined in step S4 that the measured temperature t_M has exceeded the temperature threshold value t_th (S4: YES), the control process moves to step S6.

In step S5, the normal charging current is maintained. The sequence of the control process then moves to step S3 and acquires measured temperature t_M again.

In step S6, the charging control unit 9 sets a sub-charging current. The sub-charging current is a charging current that has a lower power than the normal charging current. The lower charging current leads to less heat being generated in the housing 2, as a result of which the temperature inside the housing 2 is maintained or falls. Maintaining or reducing the temperature prevents damage to the charging cable 3 or the electronic components. After setting the sub-charging current, the control process moves to step S7.

In step S7, on the basis of the current measured temperatures from the measuring unit 3, the charging control unit 3 checks whether the measured temperature has decreased by a predetermined amount since the temperature threshold value t_th was exceeded. For this purpose, the measured temperature value at the time when the temperature threshold value t_th was exceeded is stored in a buffer and continuously compared with current measured temperatures. As long as the measured temperature t_M has not decreased by a predetermined amount (S7: NO), the sub-charging current is maintained. If the current measured temperature t_M has decreased by a predetermined amount (S7: YES), the control process returns to step S2, in which the normal charging current is set.

During the entire control process the charging process can be stopped by an external signal indicating that the charging process should be stopped. When the charging process ends, the control process also ends.

The control process can also be designed in a simplified way as a single-step temperature monitoring process. This means that only one temperature threshold value is used and the temperature profile of the sub-charging current over time is no longer monitored.

The charging device 1 according to the first embodiment is configured in such a way that the charging device 1 can be handled in a simple, reliable and damage-free manner. In particular, the following advantages are achieved.

The cable reel 8 comprises a winding mechanism. The winding mechanism prevents the charging cable 3 from being damaged by contact with the ground.

The holding device 6 is seated rotatably. As a result, the charging cable 3 can be unwound without kinking at the housing opening 5 even in a case where the charging cable 3 is led out at a sharp angle with respect to the wall on which the holding device 6 is fixed.

The charging control unit 9 is configured to reduce the normal charging current to a sub-charging current when the measuring unit 13 detects a measured temperature t_M that exceeds a predetermined temperature threshold value t_th. As a result, a further increase in temperature inside the housing 2 can be prevented. In addition, since the normal charging current is set again only after the temperature inside the housing has decreased by a predetermined value, the charging current is prevented from being switched repeatedly in a short time.

Furthermore, the charging device 1 comprises a division of the installation space and the water drainage element. This makes it possible that no water that enters the installation space remains inside the installation space and that the electronic components are protected from dirt and water.

### Second Embodiment

The second embodiment differs from the first embodiment with regard to the control sequence of the control process. Structural and construction components are identical to the ones in the first embodiment.

The flowchart in FIG. 5 represents only an exemplary control sequence. The control process according to the second embodiment differs from the one in the first embodiment particularly in step S7.

In the second embodiment the charging control unit 9 determines whether the current measured temperature t_M has fallen below a predetermined lower temperature threshold value t_th2, whereby the temperature threshold value according to the first embodiment corresponds in the second embodiment to the first temperature threshold value t_th1. If the measured temperature t_M falls below the predetermined second temperature threshold value t_th2, which is lower than the first temperature threshold value t_thl, the control process returns to step S2 and sets the normal charging current.

With the second embodiment, the same advantages as with the first embodiment can be achieved.

### Third Embodiment

The third embodiment differs from the first embodiment with regard to the control sequence of the control process. Structural and construction components are identical to the ones in the first embodiment.

The flowchart in FIG. 5 represents only an exemplary control sequence. The control process according to the third embodiment comprises one more step in the control process, which can be performed in addition to the steps of the first embodiment or the second embodiment.

The charging control unit 9 obtains the measured values from the measuring unit 13 and determines a temperature difference depending on the time or temperature change per unit of time as a differential temperature in order to detect the transient behaviour of the temperature. If the differential temperature exceeds a predetermined threshold value, the charging control unit interrupts the charging process, since the threshold value corresponds to a differential temperature, which is representative of that there is a serious malfunction in the charging device.

That is, the charging process is interrupted by the charging control unit 9 when it is determined that the temperature has increased too much within a predetermined period of time. The threshold value is therefore characteristic of a serious malfunction in the charging device 9.

With the third embodiment, the same advantages as with the first embodiment can be achieved. In addition, it is possible to quickly switch off the charging process if a serious malfunction occurs.

### Further Modifications

Regarding the description of the previous embodiments, it should be noted that various elements in the embodiments can be added or omitted. In particular it applies that:
the charging device 1 does not necessarily have to be divided into individual installation spaces,
the charging device does not necessarily have to have a water drainage element,
the length of the charging cable can be freely selected, with the charging device 1 and the preset threshold values adapted to the length of the charging cable,
the temperature threshold value does not have to be a fixed threshold value, but can be set later, for example based on an operating condition,
the holding device does not have to be fixed by means of a screw connection, whereby the holding device can be any holding device that is configured to hold the charging device 1 in a certain position,
the cable reel 8 does not necessarily have to contain a leaf spring and does not necessarily have to be spring-loaded, with another mechanism instead of a spring being provided, which enables the charging cable 3 to be automatically wound,
the temperature sensor does not necessarily have to be placed inside the cable reel installation space 23, but can also be arranged in the first or second installation space 21, 22, in which case a measured temperature is converted to a temperature inside the cable reel installation space 23 using a characteristic diagram or the threshold value is set according to a predetermined relationship between the temperature in the cable reel installation space 23 and the first or second installation space 21, 22,
the measuring unit 13 does not necessarily have to comprise a single temperature sensor, but forwards several measured values from different temperature sensors to the charging control unit 9, with several temperature sensors being placed at different positions inside the housing 2,
the relay pair 10 does not necessarily have to be provided or more than two relay units can be provided,
the charging plug 4 does not necessarily have to be a type 2 charging plug.

In addition, the charging device 1 can be advantageously modified as follows.

In order to more effectively prevent dirt particles and water from penetrating, on the housing opening 5, there can be provided a brush-like structure which is grazed against by the charging cable 3, which is guided into the housing 2. This allows dirt particles and water to be removed from the charging cable 3.

The water drainage element 14 and/or the housing 2 can be made of a heat-dissipating material so that the water drainage element 14 and/or the housing 2 serve as a heat sink and the heat generated inside the housing 2 can be better dissipated. In addition, ventilation openings can be formed in the housing.

The holding device 6 can additionally have a telescopic arm so that the holding device 6 can be extendable.

Furthermore, the charging control unit 9 can control the charging current to different sub-charging currents based on multiple temperature threshold values. For example, if a higher threshold value from among multiple threshold values is exceeded, the charging control unit 9 can control the normal charging current to a lower sub-charging current from among the sub-charging currents in order to lower the temperature faster.

In this case, the charging control unit 9 can, for example, switch the charging process via the relay pair 10 from a three-phase charging to a single-phase charging in order to achieve a greater reduction of the charging current. Thus, a sufficient lowering of the temperature inside the housing can be achieved.

Furthermore, threshold values can be set on the basis of further measured values. For example, a further measured value can indicate how much of the charging cable 3 has been unwound from the cable reel 8. If only a little has been unrolled from the charging cable 3, for example, after the temperature threshold value t_th has been exceeded, a greater temperature reduction can be required before the charging current is set to the normal charging current again.

The charging control unit 9 sets the sub-charging current as soon as a temperature threshold value t_th is exceeded. In order to simplify processing and reduce the processing load of the charging control unit 9, the charging control unit 9 can be configured to set the sub-charging current for a predetermined time. This means that no further processing of measurement data has to be carried out, while it can still be ensured that the temperature drops sufficiently. Furthermore, the time can be set based on an ambient temperature. In such a case, a characteristic diagram is stored in the charging control unit 9, which indicates how quickly the temperature in the charging device 1 decreases over time at a specific ambient temperature during charging with the sub-charging current.

In addition, a measured value that indicates how much of the charging cable 3 has been unwound from the cable reel 8 can be used to form a charging condition. Thus, it can be achieved that the charging process can only be started when a minimum length of the charging cable 3 has been unwound. This makes it more likely that critical temperature will not be exceeded even before the charging process begins.

The charging control unit 9 can obtain the parameters for controlling the charging current to a normal charging current, for example, from a smart meter or another current measuring unit. Accordingly, the charging control unit 9 can comprise further calculation units, which process the obtained data and use them for charging control, particularly when raw measurement data are forwarded.

In the present disclosure, the features of the respective embodiments and modifications can be arbitrarily combined with each other as long as there is no technical contradiction.

1. A charging device, for charging electrical energy storage devices, comprising: a cable reel which is provided with a winding mechanism;
a charging cable for charging electrical energy storage devices, which is provided with a charging plug at one end and is connected to the cable reel at the other end so that it can be wound on the cable reel;
at least one charging control unit, which is configured to control the charging of at least one electrical energy storage device; and
a measuring unit which has at least one temperature sensor, wherein
the at least one charging control unit is configured to control a charging current based on measured values of the at least one temperature sensor.

2. The charging device for charging electrical energy storage devices according to claim 1, wherein
the at least one charging control unit is configured to reduce the charging current if at least one measured value of the at least one temperature sensor exceeds a predetermined threshold value.

3. The charging device for charging electrical energy storage devices according to claim 2, wherein
the at least one charging control unit is configured to gradually reduce the charging current if at least one measured value of the at least one temperature sensor exceeds a predetermined threshold value.

4. The charging device for charging electrical energy storage devices according to claim 2, wherein
the at least one charging control unit is configured to increase the charging current if the measured value of the at least one temperature sensor, which previously exceeded the predetermined threshold value, decreases by a predetermined amount.

5. The charging device for charging electrical energy storage devices according to claim 2, wherein
the at least one charging control unit is configured to gradually increase the charging current if the measured value of the at least one temperature sensor, which previously exceeded the predetermined threshold value, decreases by a predetermined amount.

6. The charging device for charging electrical energy storage devices according to claim 1, wherein
the at least one charging control unit is configured to end a charging process if at least one measured value of the at least one temperature sensor exceeds an upper limit value and/or a differential temperature exceeds a threshold value.

7. The charging device for charging electrical energy storage devices according to claim 1, further comprising:
a sensor system that is configured to detect the length of an unwound charging cable, wherein
the at least one charging control unit is configured to set the predetermined threshold value based on the length of the unwound charging cable and to enable charging when a minimum length of the charging cable has been unwound.

8. The charging device for charging electrical energy storage devices according to claim 1, further comprising:
a holding device for fixed installation of the charging device, wherein the holding device is configured to be rotatable and/or extendable.

9. The charging device for charging electrical energy storage devices according to claim 1, wherein
the cable reel with the charging cable, the at least one charging control unit and the measuring unit are accommodated in a housing, and
the housing has at least one housing opening at which the charging cable can be led out, wherein
the cable reel has a cable guide and is spring-loaded, and the housing has dirt-collecting brushes at the housing opening at which the charging cable can be led out, and at a periphery of the housing at least one ventilation opening is formed.

10. The charging device for charging electrical energy storage devices according to claim 1, wherein
the cable reel has a water drainage element; and
the water drainage element has a water drainage opening which opens at a bottom of the housing.

11. The charging device for charging electrical energy storage devices according to claim 1, wherein
the at least one charging control unit is configured to communicate with an external measuring unit and/or external control unit and to receive data from them; and
the at least one charging control unit controls the charging current based on data of the external measuring unit and/or control unit.

12. The charging device for charging electrical energy storage devices according to claim 11, further comprising:
at least two relay units that are configured to automatically switch between a single-phase charging and a three-phase charging during a charging process of an energy storage device based on the data of the measuring unit and/or the external measuring unit and/or control unit, wherein
the first relay unit is provided for single-phase charging; and
the second relay unit is provided for three-phase charging.

13. A control process for the charging device of claim 1, comprising the following steps:
setting a normal charging current during a charging process,
obtaining a measured temperature (t_M),
comparing the measured temperature (t_M) with a temperature threshold value (t_th),
maintaining the normal charging current if it is determined that the measured temperature (t_M) is equal to or lower than the temperature threshold value (t_th) and again comparing the measured temperature (t_M) with a temperature threshold value (t_th),
setting a sub-charging current if it is determined that the measured temperature (t_M) has exceeded a temperature threshold value (t_th), the sub-charging current being lower than the normal charging current.

14. The control process for the charging device according to claim 13, further comprising the following step:
repeatedly comparing a temperature change amount (Δt_M), after the temperature threshold value (t_th) has been exceeded, with a set temperature change amount (Δt_M SOLL) and setting a normal charging current if the temperature change amount (Δt_M), after the temperature threshold value (t_th) has been exceeded, is greater than the set temperature change amount (Δt_M_SOLL).

15. The control process for the charging device according to claim 13, further comprising the following step:
repeatedly comparing the measured temperature (t_M) with a lower temperature threshold value, which is lower than the predetermined temperature threshold value, and setting a normal charging current when the measured temperature (t_M) has fallen below the lower threshold value.

16. The control process for the charging device according to claim 13, further comprising the following step:
detecting a differential temperature and disabling the charging process if it is determined that the differential temperature exceeds a threshold value of a change amount, which is characteristic of a serious malfunction.
